(19) United States
(12) Patent Application Publication
(10) Pub. No.: US 2012/0005995 A1
(43) Pub. Date: Jan. 12, 2012

(54) HOOF PROTECTION DEVICES

(76) Inventor: Leslie Emery, Vashon, WA (US)

(21) Appl. No.: 13/257,357

(22) PCT Filed: Apr. 19, 2010
(86) PCT No.: PCT/US10/31566

§ 371 Date: Sep. 19, 2011

Related U.S. Application Data
(60) Provisional application No. 61/170,662, filed on Apr. 20, 2009.
(60) Provisional application No. 61/325,469, filed on Apr. 19, 2010.

(51) Int. Cl. A01L 3/02; B68C 5/00

(52) U.S. Cl. 54/82

(57) ABSTRACT

This invention relates generally to mechanical devices, and more specifically, to hoof protection devices. In one embodiment, a hoof protection device includes a base; and a cuff comprising one or more panels, wherein the hoof protection device is configured for securing with a hoof. In another embodiment, the hoof protection device includes one or more girdles configured to wrap around at least a portion of the cuff. In another embodiment, the hoof protection device includes one or more girdles configured to securably link the cuff with one or more anchor points of one or more anchor plates. In another embodiment, the hoof protection device includes an adjustable width base comprising an open and/or at least partially closed sole. In another embodiment, the hoof protection device includes a collar configured for securing with above a hoof. In another embodiment, the hoof protection device includes a grip sock interfaceable with the cuff and a hoof.

### PRIORITY CLAIM

This application claims the benefit of U.S. provisional patent application Ser. No. 61/170,662 filed Apr. 20, 2009 (our ref. EMRY-1-1001) and U.S. provisional patent application Ser. No. 61/325,469 filed Apr. 19, 2010 (our ref. EMRY-1-1001-1). The foregoing applications are incorporated by reference in their entirety as if fully set forth herein.

### FIELD OF THE INVENTION

This invention relates generally to mechanical devices, and more specifically, to hoof protection devices.

### SUMMARY

This invention relates generally to mechanical devices, and more specifically, to hoof protection devices. In one embodiment, a hoof protection device includes a base; and a cuff comprising one or more panels, wherein the hoof protection device is configured for securing with a hoof. In another embodiment, the hoof protection device includes one or more girdles configured to wrap around at least a portion of the cuff. In another embodiment, the hoof protection device includes one or more girdles configured to securably link the cuff with one or more anchor points of one or more anchor plates. In another embodiment, the hoof protection device includes an adjustable width base comprising an open and/or at least partially closed sole. In another embodiment, the hoof protection device includes a collar configured for securing with above a hoof. In another embodiment, the hoof protection device includes a grip sock interfaceable with the cuff and a hoof.

### BRIEF DESCRIPTION OF THE DRAWINGS

Embodiments of the present invention are described in detail below with reference to the following drawings:

FIG. 1 is a perspective view of a hoof protection device, in accordance with an embodiment of the invention;

FIG. 2 is a perspective view of girdles of a hoof protection device, in accordance with embodiments of the invention;

FIG. 3 is a perspective view of guides of a hoof protection device, in accordance with embodiments of the invention;

FIG. 4 is a perspective view of fasteners of a hoof protection device, in accordance with embodiments of the invention;

FIG. 5 is a perspective view of an anchor plate of a hoof protection device, in accordance with embodiments of the invention;

FIG. 6 is a perspective view of anchor points of a hoof protection device, in accordance with an embodiment of the invention;

FIG. 7 is a perspective view of removably couplable anchor points of a hoof protection device, in accordance with embodiments of the invention;

FIG. 8 is a perspective view of adjustable width bases of a hoof protection device, in accordance with embodiments of the invention;

FIG. 9 is a perspective view of a collar of a hoof protection device, in accordance with an embodiment of the invention; and

FIG. 10 is a perspective view of a grip sock of a hoof protection device, in accordance with an embodiment of the invention.

### DETAILED DESCRIPTION

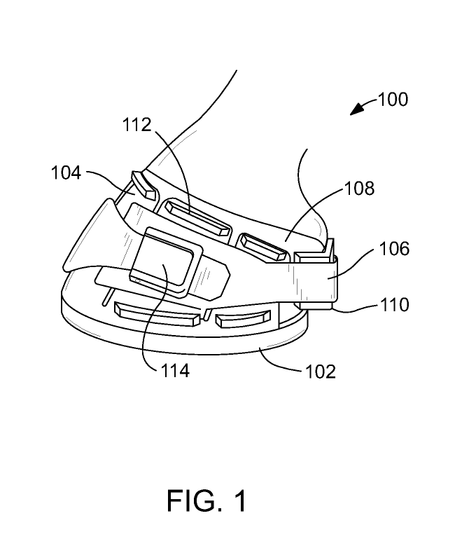

This invention relates generally to mechanical devices, and more specifically, to hoof protection devices. Specific details of certain embodiments of the invention are set forth in the following description and in FIGS. 1-10 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a perspective view of a hoof protection device, in accordance with an embodiment of the invention. In some embodiments, hoof protection device 100 includes a base 102 and a cuff 104 including one or more panels, wherein the hoof protection device 100 is configured for securing with a hoof 108. In some embodiments, the hoof protection device 100 may include one or more girdles 106 configured to wrap around at least a portion of the cuff 104.

In some embodiments, girdle 106 may include a heel pad 110. In some embodiments, cuff 104 may include one or more guides 112 to guide girdle 106. In some embodiments, girdle 106 may be secured using a fastener 114. Accordingly, hoof protection device 100 is configurable to secure with a hoof 108 in a non-invasive manner.

In some embodiments, base 102 may be composed of plastic, metal, rubber, synthetic material, composite material, and/or a combination of the same. For example, base 102 may include a metal horseshoe inner portion covered with a durable rubber outer portion. Base 102 may include an exposed metal horseshoe and/or may be a metal horseshoe. Base 102 may have an open sole (e.g., shoe) and/or a closed sole (e.g., boot). Base 102 may include a flexible width adjustable using a girdle.

In some embodiments, cuff 104 may be composed of plastic, metal, rubber, synthetic material, composite material, and/or a combination of the same. Cuff 104 may include one uniform panel or two, three, four, five, or more panels. Cuff 104 may include multiple panels configured to overlap with adjacent panels or remain separate. Cuff 104 may be angly and tensionally biased against a hoof. Cuff 104 may be configured to rise to approximately an edge of a hoof.

In some embodiments, girdle 106 may be composed of leather, plastic, metal, fabric, a synthetic material, a composite material, and/or a combination of the foregoing. Girdle 106 may be composed of a wire, a cable, a woven strap, a leather strap, and/or a combination of the foregoing. Girdle 106 may be composed of a single piece and/or a plurality of pieces. Girdle 106 may include two or more girdles. Girdle 106 may be configured to circumscribe a cuff and/or partially circumscribe a cuff. Girdle 106 may have ends coupled to posterior portions of a base, that traverse across a base, and/or that are mounted under and/or within a base. Girdle 106 may be bias cut to fit substantially over a surface of a cuff. Girdle 106 may be coupled with a cuff and/or base and/or be separable from a cuff and/or base (e.g. coupled to a posterior portion of a base). Girdle 106 may be omitted with a cuff being adhesively coupled with a hoof. Girdle 106 may supplement adhesive coupling with a hoof.

In some embodiments, heel pad 110 may be composed of rubber, fabric, plastic, a synthetic material, a composite material, and/or a combination of the foregoing. Girdle 106 may be coupled and/or anchored to a base at or near the heel pad 110. Girdle 106 may be coupled and/or anchored to a cuff.

In some embodiments, guides 112 may be composed of rubber, metal, wood, plastic, a synthetic material, a composite material, and/or a combination of the foregoing. Guides 112 may be uniformly distributed along a top and/or bottom portion of a cuff. Guides 100 112 may be elongated, shortened, and/or assume any regular and/or irregular shape. Guides 112 may be adjustable, movable, slidable, and/or rotatable.

In some embodiments, fastener 114 includes a ratchet buckle fastener. Buckle fastener 114 may include one, two, three, or more fasteners. Buckle fastener 114 may include fasteners on opposing sides of a cuff. Buckle fastener 114 may be supplemented and/or 105 complemented with adhesive, a button, a screw, a bolt, and/or other fastener.

In some embodiments, hoof protection device 100 may include reflective material and/or safety and/or decorative lighting positioned thereon. Lighting may be rechargeably powered by movement.

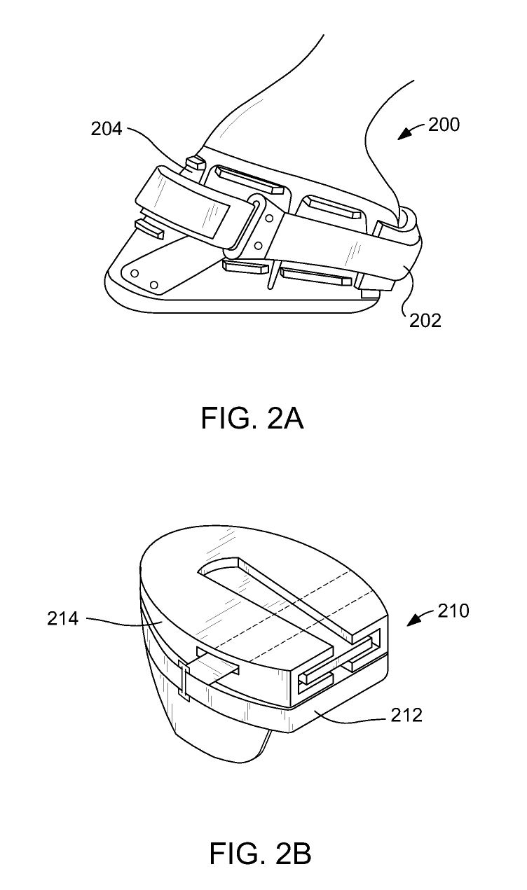

FIG. 2 is a perspective view of girdles of a hoof protection device, in 110 accordance with embodiments of the invention. In some embodiments, hoof protection device 200 includes one or more girdles 202 configured to simply and/or compoundly wrap around at least a portion of cuff 204. In some embodiments, hoof protection device 210 includes one or more girdles 212 configured to traverse across at least a portion of a base 214.

In some embodiments, girdle 202 may be configured to simply wrap around at 115 least a portion of a cuff (FIG. 1). In some embodiments, girdle 202 may be configured to compoundly wrap around at least a portion of a cuff with tension distribution downward, forward, backward, and/or upward. Girdle 202 may be configured to compoundly wrap around at least a portion of a cuff with one, two, or more points of tension distribution, which may or may not be mirrored on opposing sides.

In some embodiments, girdle 212 may be configured to traverse across an entire portion of a base. Girdle 212 may have ends that traverse across a portion of a base with the ends mounted on the base. Girdle 212 may have ends that traverse across a portion of a base with the ends crossed and mounted on the base. Girdle 212 may traverse under, through, around, and/or over a portion of the base. Girdle 212 may traverse across at least two different portions 125 of the base.

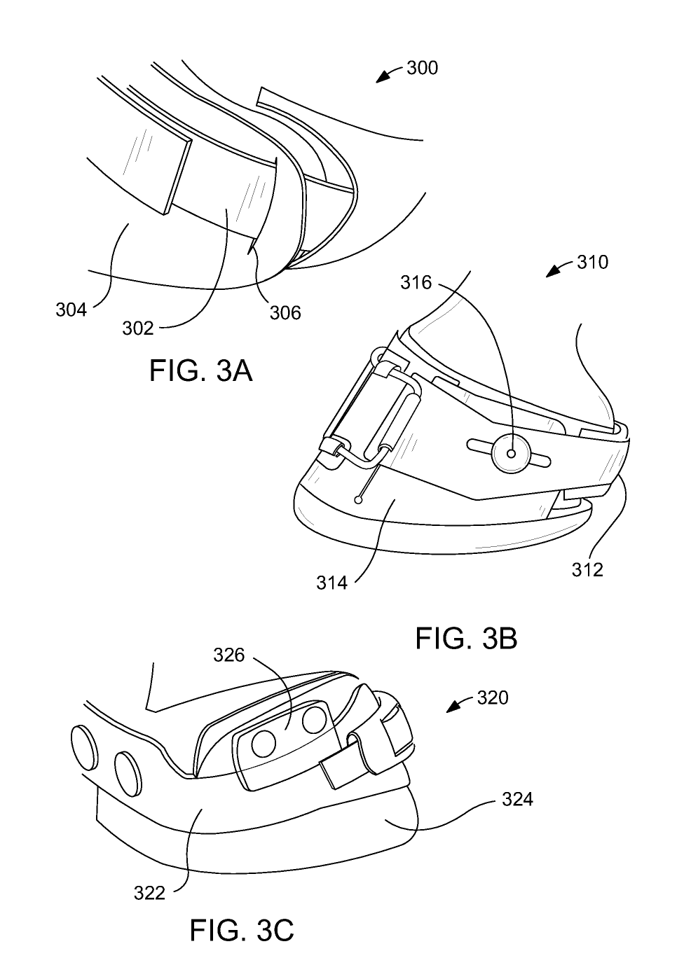

FIG. 3 is a perspective view of guides of a hoof protection device, in accordance with embodiments of the invention. In some embodiments, hoof protection device 300 includes one or more girdles 302 configured to wrap around at least a portion of cuff 304 using one or more slot guides 306. In some embodiments, hoof protection device 310 includes 130 one or more girdles 312 configured to wrap around at least a portion of cuff 314 using one or more post guides 316. In some embodiments, hoof protection device 320 includes one or more girdles 322 configured to wrap around at least a portion of cuff 324 using one or more slit guides 326.

In some embodiments, slot guides 306 may include a slot in a cuff and/or a 135 passageway coupled with a cuff. Slot guides 306 may be one, two, three, four, or more guides. Slot guides 306 may be disposed at posterior, side, and/or anterior positions on a cuff. Slot guides 306 may be positioned on a base. Slot guides 306 may be configurable to directing a girdle horizontal, vertical, angly, and/or a combination of the foregoing. Slot guides 306 may be openable, closable, movable, removable, shiftable, slidable, and/or anglable. Slot guides 306 140 may be configurable to directing a girdle around, below, over, and/or through a base and/or cuff

In some embodiments, post guides 316 may include a prong, screw, bolt, and/or other extension. Post guides 316 may be coupled with a cuff and configured to extend through an orifice of a girdle. Post guides 316 may be coupled with a girdle and configured to extend through an orifice of a cuff. Post guides 316 may include a washer, button, or other retainer. 145 Post guides 316 may be tightenable and/or loosenable. Post guides 316 may include one, two, three, or more guides. Post guides 316 may be positioned at posterior, side, and/or anterior positions on a cuff. Post guides 316 may be movable, removable, and/or anglable. Post guides 316 may be configurable to directing a girdle around, below, over, and/or through a base and/or cuff.

In some embodiments, slit guides 326 may include a retainer configured to secure an edge of a girdle. Slit guides 326 may be composed of plastic, rubber, metal, wood, a synthetic material, a composite material, and/or a combination of the foregoing. Slit guides 326 may extend across a partial width of a girdle and/or extend across an entire width of a girdle. Slit guides 326 may be one, two, three, four, or more guides. Slit guides 326 may be disposed at 155 posterior, side, and/or anterior positions on a cuff. Slit guides 326 may be positioned on a base. Slit guides 326 may be configurable to directing a girdle horizontal, vertical, angly, and/or a combination of the foregoing. Slit guides 326 may be openable, closable, movable, removable, shiftable, slidable, and/or anglable. Slit guides 326 may be tightenable and/or loosenable. Slit guides 326 may be configurable to directing a girdle around, below, over, and/or through a base 160 and/or cuff.

In some embodiments, slot guides 306, post guides 316, slit guides 326, and other guides may be combined, supplemented, and/or omitted. Other guides may include a cuff having an internal channel, a groove or impression in a cuff, attachment of a girdle directly with a cuff, securable flaps of a cuff, edges of a cuff, brackets attachable with a cuff, holes in a base, 165 fastenable straps or loops, or any other similar guide.

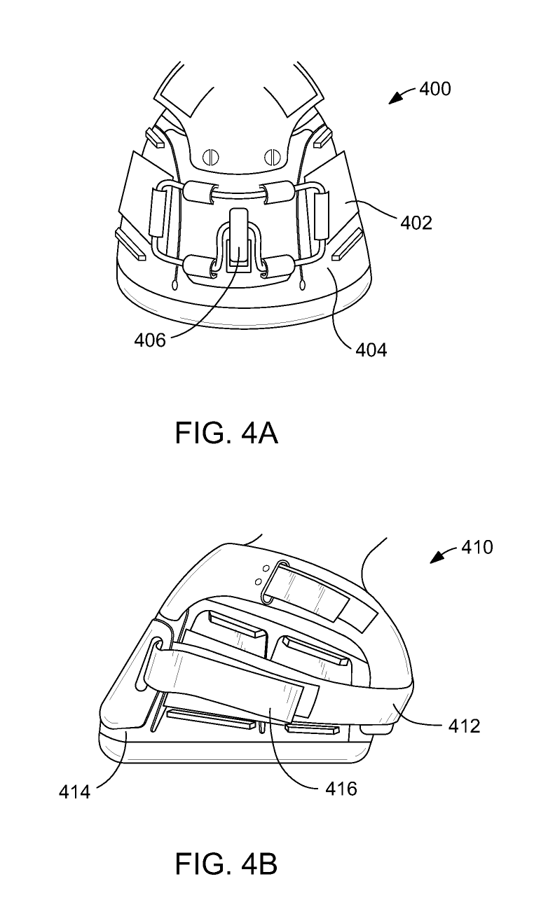

FIG. 4 is a perspective view of fasteners of a hoof protection device, in accordance with embodiments of the invention. In some embodiments, hoof protection device 400 includes one or more girdles 402 configured to wrap around at least a portion of a cuff 404 and tensionally secure using one or more cable fasteners 406. In some embodiments, hoof 170 protection device 410 includes one or more girdles 412 configured to wrap around at least a portion of a cuff 414 and tensionally secure using one or more strap fasteners 416.

In some embodiments, cable fasteners 406 may include a binder buckle, a ratchet track, a worm drive, a reel dial, and/or any other fastener configurable to controllably tightening a cable. Cable fasteners 406 may be configured to pinch, pull, twist, stretch, or 175 otherwise effectively adjust a length of a cable. Cable fasteners 406 may be positioned on a posterior, side, and/or anterior portion of a cuff and/or below or within a base. Cable fasteners 406 may include one, two, three, or more fasteners. Cable fasteners 406 may include a lock and/or removable cover portion. Cables may be a girdle, extend from a girdle, and/or couple with a girdle. Cable fasteners 406 may secure a girdle to an anchor and/or secure one end of a 180 girdle to another end of a girdle.

In some embodiments, strap fasteners 416 may include a hook and loop, double action strap binder, ratchet buckle, clasp, belt-type buckle and/or any other fastener configurable to controllably tightening a strap. Strap fasteners 416 may be positioned on posterior, side, and/or anterior portion of a cuff and/or below or within a base. Strap fasteners 416 may include 185 one, two, three, or more fasteners. Strap fasteners 416 may secure a girdle to an anchor and/or secure one end of a girdle to another end of a girdle.

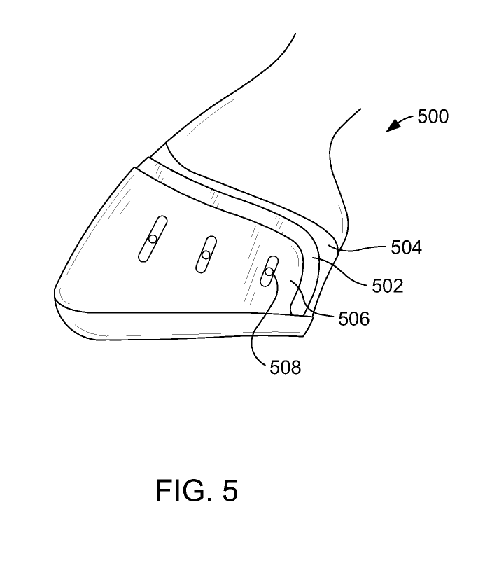

FIG. 5 is a perspective view of an anchor plate of a hoof protection device, in accordance with embodiments of the invention. In some embodiments, hoof protection device 500 includes one or more anchor plates 502 mountable on a hoof 504. In some embodiments, 190 one or more anchor plates 502 mountable on a hoof 504 are configured for frictionally interfacing with a cuff 506. In some embodiments, one or more anchor plates 502 mountable on a hoof 504 are configured for fastening with a cuff 506.

In some embodiments, anchor plates 502 are mountable on a hoof using adhesive. Anchor plates 502 may include one, two, three, or more independent portions. Anchor plates 502 may be mountable to interface with only a portion of or substantially an entire surface area of a cuff. Anchor plates 502 may be used in conjunction with other embodiments described herein, including a girdle and fastener.

In some embodiments, anchor plates 502 include are configured for frictionally interfacing with a cuff using surface irregularity, male and female components, hook and loop, adhesive, and/or other similar methodology. Anchor plates 502 may include one or more posts 508 configured to extend into and/or through one or more channels, depressions, and/or orifices of a cuff.

In some embodiments anchor plates 502 are configured for fastening with a cuff. Anchor plates 502 may include one or more posts 508 that are configured to extend through one or more orifices of a cuff and securably receive nuts. Anchor plates 502 may include one or more embedded nuts that are configured to securably receive bolts extending through one or more orifices of a cuff.

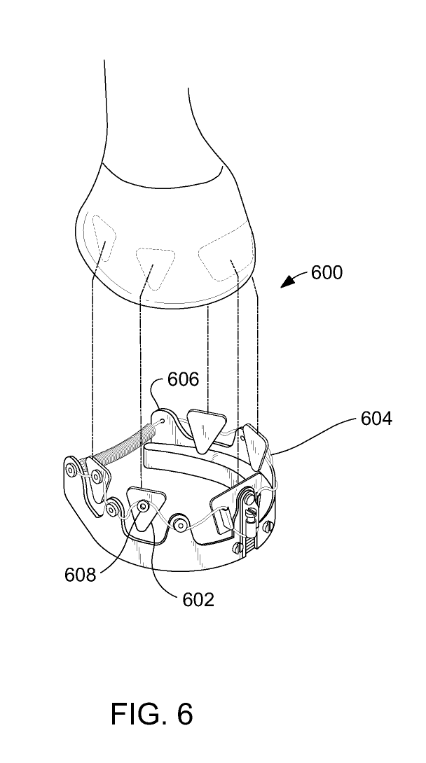

FIG. 6 is a perspective view of anchor points of a hoof protection device, in accordance with an embodiment of the invention. In some embodiments, hoof protection device 600 includes one or more anchor plates 602 mountable on a hoof. In some embodiments, hoof protection device 600 includes one or more girdles 604 configured to securably link cuff 606 with one or more anchor points 608 of the one or more anchor plates 602.

In some embodiments, anchor plates 602 are mountable on a hoof using adhesive. Anchor plates 602 may be composed of plastic, rubber, a composite material, a synthetic material, and/or a combination of the foregoing. Anchor plates 602 may include one, two, three, or more anchor plates. Anchor plates 602 may be uniformly and/or non-uniformly distributable on hoof. Anchor plates 602 may be of similar and/or different sizes and/or shapes. Anchor plates 602 may be at least partially exposed by contours of a cuff.

In some embodiments, anchor points 608 are hooks, prongs, ridges, channels, holes, edges, or other similar structures configured for receiving a girdle. Anchor points 608 may be composed of rubber, plastic, metal, wood, a composite material, a synthetic material, and/or a combination of the foregoing. Anchor points 608 may include one, two, three, or more anchor points. Anchor points 608 may include one, two, or more anchor points on one anchor plate. Anchor points 608 may be movable, removable, slidable, shiftable, and/or rotatable relative to an anchor plate.

In some embodiments, girdle 604 includes a cable configured to lace with anchor points. Girdle 604 may include a cable secured to an anchor point. Girdle 604 may include a parallel cable configured to lace with parallel anchor points. Girdle 604 may include a strap and/or a strap portion. Girdle 604 may include one, two, three, or more girdles. Girdle 604 may be coupled with and/or laceable with a cuff and/or base. Girdle 604 may circumscribe a cuff and include a pad and/or protective channel for interfacing with a hoof heel. Girdle 604 may traverse under, across, over, and/or through a base.

In some embodiments, cuff 604 includes a shape to accommodate anchor plates. Cuff 604 may include contours to configurable to substantially expose anchor plates. Cuff 604 may include contours configurable to substantially cover anchor plates. Cuff 604 may include contours configurable to substantially expose anchor points. Cuff 604 may include one or more orifices configurable to allowing anchor points to protrude through. Cuff 604 may include curved and/or sharply angled contours. Cuff 604 may also be substantially minimized.

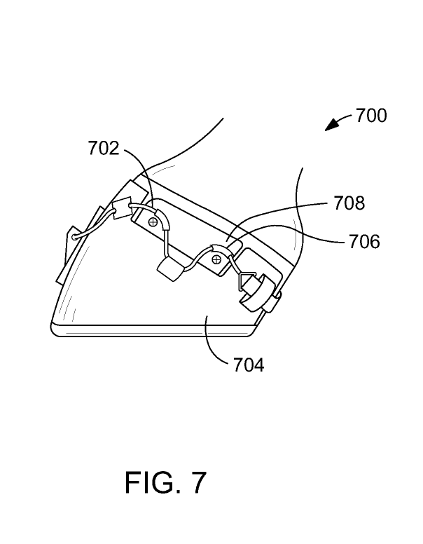

FIG. 7 is a perspective view of removably couplable anchor points of a hoof protection device, in accordance with embodiments of the invention. In some embodiments, hoof protection device 700 includes one or more girdles 702 configured to securably link cuff 704 with one or more anchor points 706 removably couplable with the one or more anchor plates 708. Accordingly, anchor plates 708 may be disposed on a hoof during and/or between uses of hoof protection device 700.

In some embodiments, anchor plates 708 may include one or more embedded bolts and/or nuts configured for removably securing an anchor point. Anchor plates 708 may include a flange or other similar structure for receiving a hook and/or clasp for removably securing an anchor point. Anchor plates 708 may include one or more depressions and/or extensions for snapping, interlocking, and/or mateably receiving an anchor point.

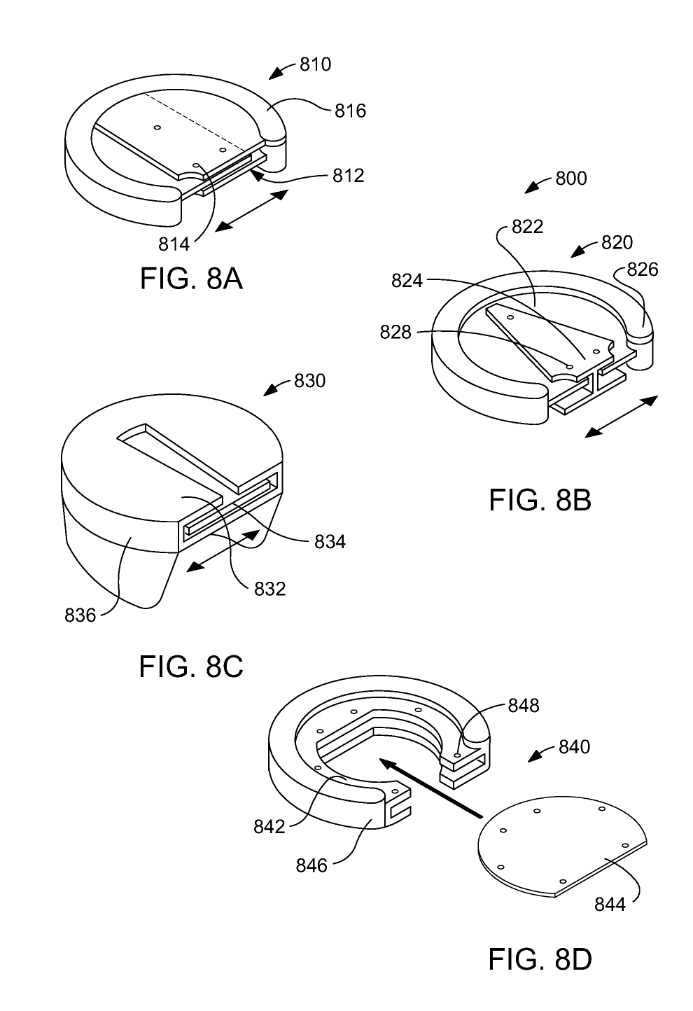

FIG. 8 is a perspective view of adjustable width bases of a hoof protection device, in accordance with embodiments of the invention. In some embodiments, hoof protection devices 800 include adjustable and securably adjustable width bases comprising open and/or at least partially closed soles. Hoof protection devices 800 may be composed of composed of metal, rubber, wood, plastic, a composite material, a synthetic material, and/or a combination of the foregoing.

In some embodiments, hoof protection device 810 includes three overlapping plates 812 expandable and/or contractible with opposing ends of base 816. Overlapping plates 812 may include two, three, four, or more overlapping plates. Overlapping plates 812 may include one or more apertures for exposing a hoof For example, overlapping plates 812 may be limited in shape to that surrounding any fasteners. Overlapping plates 812 may be securable in alignment using one or more fasteners 814. Overlapping plates 812 may be securable in alignment in coordination with a girdle and/or an independent cinching mechanism. Overlapping plates 812 may be contractibly biased to automatically adjust to a hoof width. Overlapping plates 812 may include traction surface irregularity.

In some embodiments, hoof protection device 820 includes a split plate 822 insertable within a slotted tongue 824 expandable and/or contractible with opposing ends of base 826. Split plate 822 may include a slotted portion for overlapping above and/or below a slotted tongue. Slotted tongue 824 and split plate 822 may be fixedly and/or movably coupled anteriorly. Slotted tongue 824 may be removably couplable. Split plate 822 and/or slotted tongue 824 may include one or more apertures for exposing a hoof. For example, split plate 822 may be limited in shape to that surrounding any fasteners. Slotted tongue 824 may define a shape that extends more fully and/or fully across base. Split plate 822 and/or slotted tongue 824 may be securable in alignment using one or more fasteners 828. Split plate 822 and/or slotted tongue 824 may be securable in alignment in coordination with a girdle and/or an independent cinching mechanism. Split plate 822 and/or slotted tongue 824 may be contractibly biased to automatically adjust to a hoof width upon use. Split plate 822 and/or slotted tongue 824 may include traction surface irregularity.

In some embodiments, hoof protection device 830 includes a tongue 834 insertable within a slotted plate 832 expandable and/or contractible with opposing ends of base 836. Slotted plate 832 may be an extension of base. Tongue 834 and/or slotted plate 832 may be fixedly and/or movably coupled anteriorly. Tongue 834 and/or slotted plate 832 may be securable in alignment using one or more fasteners. Tongue 834 and/or slotted plate 832 may be securable in alignment in coordination with a girdle and/or an independent cinching mechanism. Slotted plate 832 may include rubber and/or elastic between opposing sides for coverage and/or provide tensional bias against opposing ends of base. Slotted plate 832 and tongue 834 may be contractibly biased to automatically adjust to a hoof width upon use. Slotted plate 832 may include traction surface irregularity.

In some embodiments, hoof protection device 840 includes a custom plate 844 insertable within a slotted plate 842 expandable and/or contractible with opposing ends of base 846. Slotted plate 842 and custom plate 844 may be securable in alignment using one or more fasteners 848. Custom plate 844 may embody various widths, diameters, perimeters curvatures, thicknesses, and/or other shapes. Custom plate 844 may include one or more apertures for exposing a hoof. Slotted plate 842 may extend partially around base and/or fully around base. Slotted plate 842 may be composed of independent sections. Slotted plate 842 may extend more fully and/or fully across base. Slotted plate 842 may have upper and/or bottom plates embodying different shapes. Slotted plate 842 and custom plate 844 may be securable in alignment in coordination with a girdle and/or an independent cinching mechanism. Slotted plate 842 and custom plate 844 may include traction surface irregularity. Custom plate 844 may be selected from an array of custom plate sizes and/or shapes.

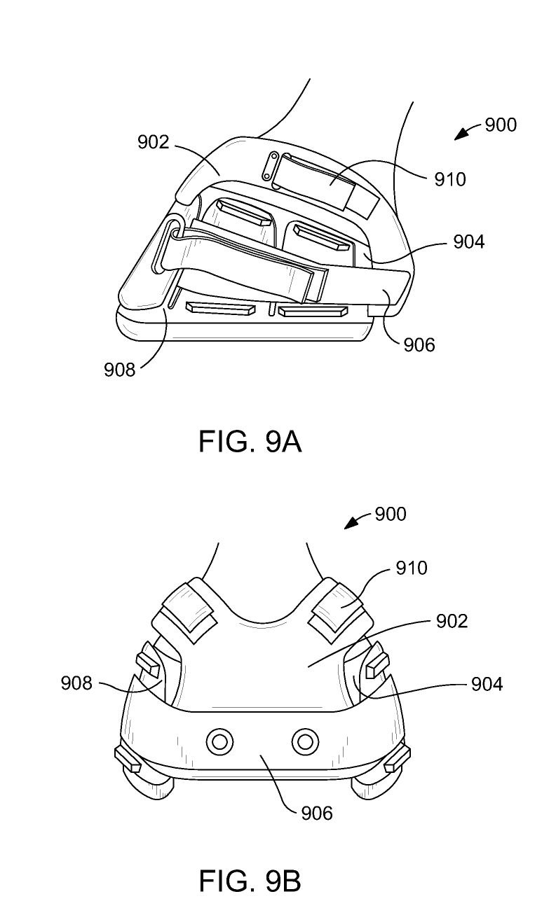

FIG. 9 is a perspective view of a collar of a hoof protection device, in accordance with an embodiment of the invention. In some embodiments, hoof protection device 900 includes a collar 902 configured for securing with above a hoof 904.

In some embodiments, collar 902 is coupled with a girdle 906 posteriorly and a cuff 908 anteriorly and configured to secure using one or more fasteners 910 (e.g., single yoked collar or double yoked collar). Collar may be composed of leather, rubber, an elastic/stretch material, fabric, a synthetic material, a composite material, and/or a combination of the foregoing. Collar 902 may include one or more internal pads. Collar 902 may be coupled only with a girdle and/or only with a cuff. Collar 902 may be coupled at different positions with a girdle and/or a cuff. Collar 902 may be removably couplable with a girdle and/or cuff. Collar 902 may be at least partially positioned over a cuff, at a point just above a cuff, and/or at a point substantially above a cuff. Collar 902 may include two or more parallel and/or independent collars. Fasteners 910 may include two or more fasteners. Fasteners 910 may be omitted and collar may embody a sleeve and/or loop. Fasteners 910 may include a hook and loop, double back buckle, button, ratchet buckle, and/or a combination of the foregoing.

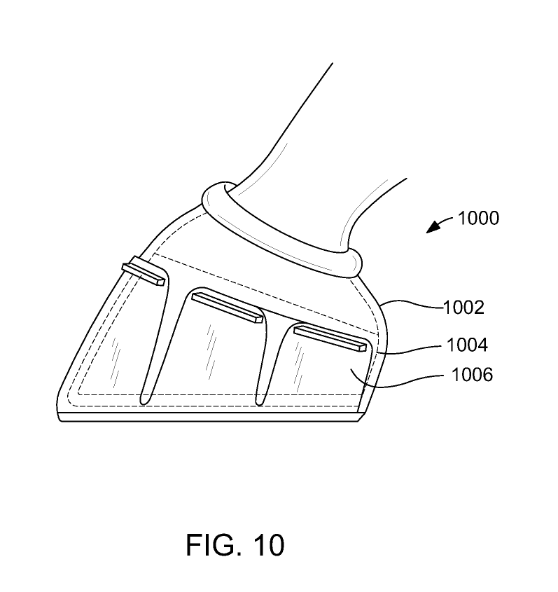

FIG. 10 is a perspective view of a grip sock of a hoof protection device, in accordance with an embodiment of the invention. In some embodiments, hoof protection device 1000 includes a grip sock 1002 interfaceable with a cuff 1006 and a hoof 1004.

In some embodiments, grip sock 1002 is a sleeve disposable between a hoof 1004 and a cuff 1006. Grip sock 1002 may be composed of rubber, plastic, fabric, foam, a compressible material, an elastic material, a synthetic material, a composite material, and/or a combination of the foregoing. Grip sock 1002 may embody a contoured shape for sizing to a hoof Grip sock 1002 may include an elastic upper rim.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is Claimed is:

1. A hoof protection device comprising:
a base; and
a cuff comprising one or more panels,
wherein the hoof protection device is configured for securing with a hoof

2. The hoof protection device of claim 1, further comprising:
one or more girdles configured to wrap around at least a portion of the cuff.

3. The hoof protection device of claim 2, wherein the one or more girdles configured to wrap around at least a portion of the cuff comprises:
one or more girdles with a heel pad.

4. The hoof protection device of claim 2, wherein the one or more girdles configured to wrap around at least a portion of the cuff comprises:
one or more girdles configured to simply and/or compoundly wrap around at least a portion of the cuff.

5. The hoof protection device of claim 2, wherein the one or more girdles configured to wrap around at least a portion of the cuff comprises:
one or more girdles configured to traverse across at least a portion of the base.

6. The hoof protection device of claim 2, wherein the one or more girdles configured to wrap around at least a portion of the cuff comprises:
one or more girdles configured to wrap around at least a portion of the cuff using one or more guides.

7. The hoof protection device of claim 2, wherein the one or more girdles configured to wrap around at least a portion of the cuff comprises:
one or more girdles configured to wrap around at least a portion of the cuff and tensionally secure using one or more fasteners.

8. The hoof protection device of claim 1, further comprising:
one or more anchor plates mountable on a hoof

9. The hoof protection device of claim 8, wherein the one or more anchor plates mountable on a hoof comprises:
one or more anchor plates mountable on a hoof and configured for frictionally interfacing with the cuff.

10. The hoof protection device of claim 8, wherein the one or more anchor plates mountable on a hoof comprises:
one or more anchor plates mountable on a hoof and configured for fastening with the cuff.

11. The hoof protection device of claim 8, further comprising:
one or more girdles configured to securably link the cuff with one or more anchor points of the one or more anchor plates.

12. The hoof protection device of claim 11, wherein the one or more girdles configured to securably link the cuff with one or more anchor points of the one or more anchor plates comprises:
one or more girdles configured to securably link the cuff with one or more anchor points removably couplable with the one or more anchor plates.

13. The hoof protection device of claim 1, wherein the base comprises:
a base comprising an open and/or at least partially closed sole.

14. The hoof protection device of claim 13, wherein the base comprising an open and/or at least partially closed sole comprises:
an adjustable width base comprising an open and/or at least partially closed sole.

15. The hoof protection device of claim 13, wherein the base comprising an open and/or at least partially closed sole comprises:
a securably adjustable width base comprising an open and/or at least partially closed sole.

16. The hoof protection device of claim 1, further comprising:
a collar configured for securing with above a hoof.

17. The hoof protection device of claim 1, further comprising:
a grip sock interfaceable with the cuff and a hoof

18. A hoof protection device comprising:
a base; and
two or more overlapping plates.

19. The hoof protection device of claim 18, wherein a width of the base is adjustable by securably aligning the two or more overlapping plates.

20. The hoof protection device of claim 18, wherein a width of the base is contractibly biased.
